(19) United States
(12) Patent Application Publication
(10) Pub. No.: US 2019/0104110 A1
(43) Pub. Date: Apr. 4, 2019

(54) METHOD AND SYSTEM FOR CONTROLLING TRANSMISSION OF DATA PACKETS IN A NETWORK

(71) Applicant: CARIBBEAN EQUITIES LLC, Urbandale, IA (US)

(72) Inventor: Mark KLADIVO, Urbandale, IA (US)

(21) Appl. No.: 15/719,569

(22) Filed: Sep. 29, 2017

(51) Int. Cl. H04L 29/06; H04L 12/823; H04L 12/24

(52) U.S. Cl. CPC H04L 63/0263; H04L 61/20; H04L 41/0893; H04L 47/32

(57) ABSTRACT

A computer-implemented method and system for controlling transmission of data packets in a communication network provided. The method includes facilitating, by a remote server, a platform for defining a plurality of rules. The rules are defined by an administrator of the remote server. The plurality of rules is configured to set conditions for communicating data packets to a user device in communication network. The method includes enabling downloading, by the remote server, the plurality of rules at a network device configured in-line with the user device in the communication network. The method includes enabling the network device to forward data packets to the user device if data packets satisfy the conditions set by the plurality of rules. The method further includes enabling the network device to restrict communication of data packets to the user device if data packets do not satisfy the conditions set by the plurality of rules.

### TECHNICAL FIELD

The present disclosure relates generally to network security and, more particularly to, data packet filters such as firewalls within a data communication network.

### BACKGROUND

Information on electronic devices often encounters threats and risks on the Internet that may destroy the information. Protection of information resources has long been a top priority of all companies and organizations that utilize technology as a means of going to market. Typically, this protection has been implemented at the entrance to a network, usually by implementing a firewall device.

Firewalls allow certain traffic into the network and block everything else. Firewalls examine the header of each packet based on a specific set of rules, and on that basis, decide to allow or prevent the data packet from passing the network.

Recently, ransomware toolkits have become available that allow malicious code to bypass firewalls by entering the network as allowed traffic, typically through email or web browsing. Once the insecure toolkit is inside the firewall, there is very little protection for the rest of the network including the devices connected to the network.

In another scenario, major software companies that provide operating systems, end support for operating systems on a regular and published schedule. This means that security patches are no longer developed for threats for these operating systems. Many systems, deployed across many industries, utilize these end-of-life, non-supported operating systems as the basis for their hardware deployment. These systems have a useful life beyond the end-of-life defined for the system's operating system. However, with outdated security patches, these operating systems become vulnerable to internet threats and risks.

Most of these systems have internal controls which, when implemented properly, can mitigate threats and risks. However, new toolkits often include options to disable these internal controls, rendering them useless even if they were implemented properly. Additionally, some of these controls require updates that are also not being provided by the manufacturer.

Therefore, a need exists in the field for network packet filtering solutions, that can be remotely implemented, that are not subject to end-of-life support restrictions, and that can protect systems from threats that bypass the traditional firewalls.

### SUMMARY

Various embodiments of the present disclosure provide systems and methods for controlling transmission of data packets in a network.

An embodiment provides a computer-implemented method for controlling transmission of data packets in a communication network. The method includes facilitating, by a remote server, a platform for defining a plurality of rules. The rules are defined by an administrator of the remote server. The plurality of rules are configured to set conditions for communicating data packets to a user device in a communication network. The method includes enabling downloading, by the remote server, the plurality of rules at a network device configured in-line with the user device in the communication network. The method further includes enabling the network device to forward the data packets to the user device if the data packets satisfy the conditions set by the plurality of rules. The method further includes enabling the network device to restrict communication of the data packets to the user device if the data packets do not satisfy the conditions set by the plurality of rules.

Another embodiment provides a system for controlling transmission of data packets in a communication network. The system comprises a remote server and a network device. The remote server comprises a plurality of rules configured to set conditions to communicate data packets to a user device in the network. The network device is configured in-line with the user device in the network. The network device is configured to download the plurality of rules from the remote server. The network device is further configured to forward the data packets to the user device if the data packets satisfy the conditions set by the plurality of rules and restrict communication of the data packets to the user device if the data packets do not satisfy the conditions set by the plurality of rules.

Another embodiment provides a remote server. The remote server includes a memory configured to store a plurality of rules configured to set conditions for exchanging data packets with one or more communication devices in a communication network. The remote server further includes a processor configured to enable a network device to download the plurality of rules, wherein the network device is configured in-line with the one or more communication devices in the communication network. The processor is further configured to allow communication of the data packets to the one or more communication devices if the data packets satisfy the conditions set by the plurality of rules. The processor is further configured to restrict communication of the data packets to the one or more communication devices if the data packets do not satisfy the conditions set by the plurality of rules.

### BRIEF DESCRIPTION OF THE FIGURES

For a more complete understanding of example embodiments of the present technology, reference is now made to the following descriptions taken in connection with the accompanying drawings in which:

FIG. 1 is a simplified illustration of an environment in which a system for controlling transmission of data packets in a network is deployed, in accordance with some embodiments;

FIG. 2 is a simplified block diagram of a remote server of the system of FIG. 1.

FIG. 3 is a simplified illustration of a rules database, storing plurality of rules, included in the remote server of FIG. 2;

FIG. 4 is a simplified block diagram of a network device of the system of FIG. 1;

FIG. 5 is a flowchart illustrating an example method for controlling transmission of data packets in a network; and

FIG. 6 is a simplified block diagram of a server system, in accordance with one embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for controlling transmission of data packets in a network.

Embodiments provide systems and methods for controlling transmission of data packets in a network. A system includes a network device to which plurality of user devices, such as a computer, a laptop, a smart phone etc., are connected, thereby forming a communication network. The communication network facilitates the plurality of devices to connect with the Internet (the World Wide Web). The network device may be placed into the communication network between the plurality of user devices and the rest of the communication network. The system further includes a remote server. The remote server facilitates a platform for defining a plurality of rules. The plurality of rules may be defined by an administrator (user) associated with the remote server. The rules are configured to set conditions for communicating data packets to the plurality of user devices connected to the network device. At least one among the plurality of user devices may query information from a web server by way of browsing a website associated with the web server. Further, information and files may be exchanged or shared among the communication devices in the communication network. Requested information from one or more sources, in the form of data packets, is received at a port of the network device. The data packets are processed at the network device before being forwarded to a port of the user device. The network device is configured to download the plurality of rules from the remote server. The rules at the network device enable forwarding the data packets, to the port corresponding to the user device querying the information if the data packets satisfy the conditions set by the plurality of rules. The rules at the network enable restricting communication of the data packets to the one or more user devices if the data packets do not satisfy the conditions set by the plurality of rules. The rules define what type of data packets may be allowed into the user device(s).

The platform facilitated by the remote server is further used by the administrator to define network addresses associated with the plurality of user devices of the network. The administrator defines one or more ports and the network address associated with the network device. The administrator further defines ports and network addresses associated with the plurality of user devices. The administrator creates an identifier for the network device, which is used while defining the plurality of rules using the platform facilitated by the remote server. The network device is referred to using the identifier in the plurality of rules. The administrator assigns the plurality of rules to specific network devices. The network device determines when the plurality of rules have been created and download the plurality of rules and implement the rules allowing traffic that has been specifically allowed and denying all other traffic based on the plurality of rules.

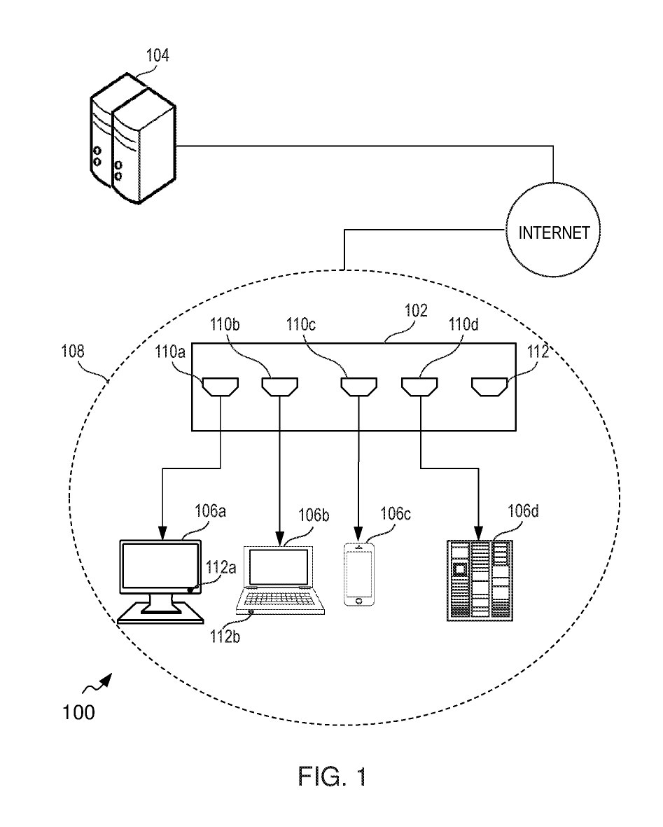

FIG. 1 is a simplified illustration of an environment in which a system 100, for controlling transmission of data packets in a communication network, is deployed, in accordance with at least some embodiments disclosed herein. The environment maybe, as an example, a company, an industry, a medical facility, a university or any organization where a plurality of electronic devices/communication devices such as computers, smart phones, servers, etc., are deployed. One or more of these devices are connected to the Internet through one or more network devices. The communication devices may be exposed to risks, threats, malicious software and toolkits on the Internet, such as virus. The threats may enter the communication devices when they exchange data among one another or when they request html pages from information sources such as web servers by way of web browsing and through email messages. The remote server includes a plurality of rules which set conditions for forwarding the data to the devices. The rules further enable restricting or blocking specific data from entering the communication devices if the data does not satisfy any condition set by the plurality of rules.

As seen in FIG. 1, in an embodiment, the system 100 includes a network device 102 and a remote server 104. The network device 102 is connected to a plurality of user devices 106a, 106b, 106c and 106d as an example. The user devices 106a, 106b, 106c and 106d are examples of communication devices that are deployed in the environment and are operated by users. The network device 102 facilitates the plurality of user devices 106a, 106b, 106c and 106d to connect with the Internet using a communication network 108. The system 100 may further include more than one network devices similar to network device 102. The user devices 106a, 106b, 106c and 106d may exchange data and files among one another using the communication network 108.

The network device 102 may be placed into the communication network 108 between the user devices 106a, 106b, 106c and 106d and the rest of the communication network 108. The network device 102 is configured such that unlike traditional firewall devices, the network device's placement between the user devices 106a, 106b, 106c and 106d and the rest of the communication network 108 requires no change in network address for passing traffic from one network to another. The terms “data packet(s)” and “traffic” may be interchangeably used throughout the disclosure.

The user devices 106a, 106b, 106c and 106d may include, but are not limited to, a personal computer (PC), a tablet device, a personal digital assistant (PDA), a smart phone, a laptop and an image acquisition device. The user devices 106a, 106b, 106c and 106d may further include servers, data centers and computer systems which may be used as information resources of an organization. The user devices 106a, 106b, 106c and 106d may further include devices with operating systems for which the security support has been ended which means that security patches are no longer developed for threats for such operating systems. The user devices 106a, 106b, 106c and 106d may also be referred to as “communication devices”, “end user's devices” and “electronic devices” throughout the disclosure.

The network device 102 may be a network switch or a router including a plurality of ports to which the user devices 106a, 106b, 106c and 106d may be connected. In an example, the network device 102 connects communication devices 106a, 106b, 106c and 106d together on the communication network 108 by using packet switching. The network device 102 receives, processes, and forwards data to a desired communication device (e.g. 106a). The network device 102 manages the flow of data across the communication network 108 by transmitting a data packet only to the user device (e.g. 106a) for which the data packet is intended.

A user device (e.g. the user device 106a) may optionally query or request information, such as a HTML page/webpage from a source such as a web server by way of web browsing. The user devices 106a, 106b, 106c and 106d may also request and exchange information and files among one another. One or more user devices requesting data from the one or more other user devices may be the destination devices and the one or more user devices transmitting the requested data to the destination devices may be the sources or source devices. Requested information, in the form of data packets, is received at the network device 102. The data packets are processed at the network device 102 by applying the plurality of rules. For instance, if the user device 106a is a destination device, the data packets may be forwarded to the user device 106a, requesting the information, upon application of the plurality of rules.

In an embodiment, one or more of the user devices may include at least one port each for establishing connection with the network device 102. As seen in FIG. 1 the ports 112a and 112b of the user devices 106a and 106b may be connected to the network device 102. Ports of the user devices 106c and 106d are not shown in FIG. 1. It shall be noted that the placement of ports 112a and 112b as shown in FIG. 1 is exemplary and the actual placement may differ from what is illustrated in FIG. 1.

The network device 102 includes a plurality of ports such as ports 110a, 110b, 110c and 110d. Each user device among the user devices 106a, 106b, 106c and 106d is connected to respective ports 110a, 110b, 110c and 110d. Each of the ports 110a, 110b, 110c and 110d is configured to either receive from or transmit to the connected user devices 106a, 106b, 106c and 106d. For instance, if the user device 106a is connected to port 110a, then the port 110a receives from or transmits to the connected user device 106a. The network device 102 can be of any technology, topology and manufacture, well known to a person skilled in the art. The number of ports and how they are configured within the network device 102 are implementation specific and not germane to the disclosure.

Network traffic is destined to a logical port. As an example, non-encrypted web traffic is requested on port 80, encrypted web traffic is on port 443, and email is often on port 25. So, in a mail server that has a webmail interface, a single IP address, Ethernet interface, and network cable could serve the server, and it would know that if the request came in on port 25, it is inbound email. If it came in on port 443, it is someone using the webmail interface. The ports are a way for the systems to determine what to do with the traffic.

It shall be noted that the user devices 106a, 106b, 106c and 106d may be connected to the network device 102 by means of Ethernet LAN cables. However, in another scenario, the communication devices 106a, 106b, 106c and 106d may be connected to the network device 102 in a wireless manner, thereby forming a Wifi network (such as the communication network 108).

The remote server 104 may be a virtual server such as a cloud server. A third party entity may host the remote server 104. Alternatively, the remote server 104 may be a physical server located at a third party entity's facility. The third party entity may be a network administrator, a network engineer or any software code developing entity responsible for defining the plurality of rules. In another embodiment, the rules may be defined by an end user for example a user of the any of the communication devices 106a, 106b, 106c and 106d. The remote server 104 may include a memory for storing the plurality of rules. In another embodiment, the remote server 104 may be an example of a rules engine.

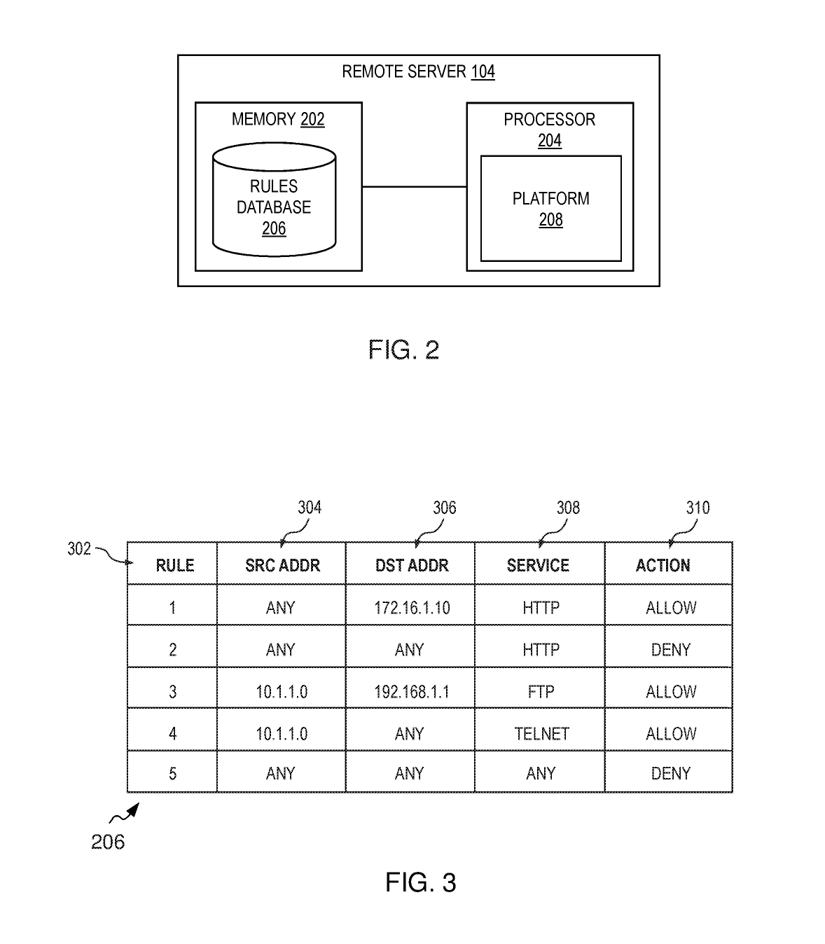

Referring now to FIG. 2, a simplified block diagram of the remote server 104 for facilitating the platform for defining the plurality of rules is illustrated. In an example embodiment, the remote server 104 includes a memory 202 and a processor 204 in operative communication with the memory 202. The memory 202 stores the plurality of rules in a rules database 206. The processor 204 facilitates a platform 208 which can be accessed by an administrator of the remote server 104 to define the plurality of rules. The platform 208 may be a website, an administration tool or a software application facilitating a user interface that allows the administrator of the remote server 104 to define network addresses, ports and services, among others, corresponding to the network device 102. The platform 208 further enables defining network addresses and input/output ports corresponding to the plurality of communication devices 106a, 106b, 106c and 106d connected to the network device 102. The definition of the network addresses and the ports associated with the network device 102 are combined to create or define the plurality of rules. The plurality of rules are then deployed to the network device 102 or are made available for download by the network device 102. The plurality of rules may include general stateful rules used in the traditional firewalls.

In an embodiment, a communication network, such as communication network 108 may include more than one network devices 102. The remote server 104 may facilitate defining plurality of rules for each of such network devices. For instance, there may be sets of plurality of rules depending upon the types and configurations of network devices. Each set of the plurality of rules in the rules database 206 may be assigned by the administrator to a specific network device based on the configuration and type of the network devices. A network device is allowed to download the set of plurality of rules, which are specific to the network device. The plurality of rules may be predefined at the remote server 104 and may be modified when there is a change in configuration in a network device.

The platform 208 may further provide instructions to the administrator to set or create identifiers (not shown) for all network devices (including network device 102) available in the communication network 108. Creating identifiers for the network device may involve associating the defined ports, network addresses and services (or protocols such as TCP/IP, HTTP etc) with the identifiers. These identifiers are used in the plurality of rules so as to refer to the network device 102. Identifiers may be names assigned by the administrator, which are substitutes for the network device's network address and the ports definition, as an example. For instance, let's assume that a network device (e.g. network device 102) has the network address defined as 172.24.231.118. An identifier “Switch 00” may be set for the network device 102 with the network address 172.24.231.118. The rules would then reference “Switch 00” instead of 172.24.231.118.

The remote server 104 facilitates auto updating of the plurality of rules to the network device 102 when an identifier used in the rules has a change in configuration such as network address, port, etc. In the above example, if the address of “Switch 00” changes to 10.10.10.123, it could be changed or set in the identifier “Switch 00” and the rules associated with the identifier “Switch 00” would automatically get updated.

The administrator can create a group of network addresses and create an identifier for the group of network addresses. Likewise, the administrator can create a group of ports and create an identifier for the group of ports. The rules can be translated into any programming language as required by the specific network device. The network device determines when a new rule has been defined and downloads and implements it.

The network device 102 further sends usage and threat information to the remote server 104. The network device 102 or the remote server 104 further processes the threat information into reports and diagnostics.

Referring to FIG. 3, an example rules database 206 is illustrated. The rules database 206 includes a column 302 for rule number, and a column 304 for the source (Internet Protocol) IP address. The column 304 of source IP address is exemplarily titled as “SRC ADDR”. The source IP address may refer to a network address of a source device from which data may be transmitted. In the present disclosure, the source device may refer to a web server or any other information source. In another embodiment, the source device may refer to the network address of one of the communication devices (e.g. communication device 106a), such as the image acquisition device from which rest of the communication devices 106b, 106c and 106d may receive information. The rules database 206 includes a column 306 for destination IP address. The column 306 of destination IP address is exemplarily titled as “DST ADDR”. The destination IP address may refer to network address of a communication device (e.g. communication device 106b) that may have requested or queried information from the source device. The rules database 206 further includes a column 308 for service (or protocol) and a column 310 for actions. Actions may include forwarding data packets to a user device and restricting or blocking data packets from entering into user device. It shall be noted that the representation of the rules database 206, as shown in FIG. 3, is exemplary and only for the purposes of explanation. The data stored in the rules database 206 may be in a different format (well-known in the art) from that of the illustration of FIG. 3.

As seen in FIG. 3, the rules database 206 includes five example rules in five rows of the column 302. Rule 1 allows HTTP (Hyper-Text Transfer Protocol) data from any source IP address to a device with destination IP address 172.16.1.10. All other HTTP traffic is denied in accordance with Rule 2. That is, if HTTP traffic does not match the Rule 1, it is denied. Rules 3 and 4 allow FTP (File Transfer Protocol) traffic from source IP address 10.1.1.0 to destination IP address 192.168.1.15 and Telnet connections from source IP address 10.1.1.0 to any destination IP address, respectively. Rule 5 in the rules database 206 denies data packets related to any service from any source IP address to any destination IP address.

Referring to the plurality of rules in the rules database 206, it can be seen that the Rule 5 in the rules database 206 is designed to prohibit all that is not expressly permitted in the first four rules. Hence, if a data packet does not match any of the first four rules and it matches Rule 5, and the data packet is denied.

In general, when a data packet is received in the network device 102, some of the header field values of the data packet are compared to the plurality of rules in the rules database 206, and when a matching rule is found, the action related to the corresponding rule is performed.

The plurality of rules are data packet filtering rules and each rule comprise at least one condition as seen in Rules 1 to 4 in FIG. 3 for allowing or restricting communication of data packets from the network device 102 to the user devices 106a, 106b, 106c and 106d and from the user devices 106a, 106b, 106c and 106d to the network device 102. The objective of implementing the plurality of rules in the network device 102 is to control the incoming and outgoing traffic by analyzing the traffic (data packets) and determining whether the data packets should be allowed to pass or halt based on the source and destination IP addresses protocols and ports.

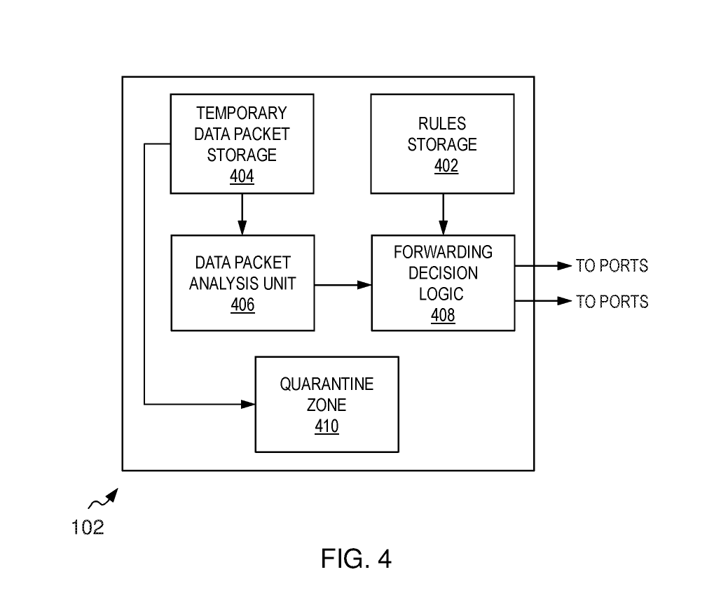

FIG. 4 is a simplified illustration of an example network device 102, in accordance with some embodiments of the disclosure. The network device 102 includes a rules storage 402, which stores the plurality of rules downloaded from the remote server 104. The plurality of rules in the rules storage 402 may be instances of the plurality of rules present in the rules database 206 of the remote server 104. The network device 102 further includes a temporary data packet storage 404, a data packet analysis unit 406, and a forwarding decision logic 408. There are multiple ports (shown in FIG. 1) in the network device 102.

The temporary packet storage 404 holds incoming data packets temporarily while other components of the network device 102 determine which port the data packets should be forwarded to. Depending on the size of the packets, the temporary packet storage 404 may hold several packets. Alternatively, the temporary packet storage 404 may hold only a portion of a packet.

The data packet analysis unit 406 extracts the source and destination IP addresses from the packets and forwards the addresses to the forwarding decision logic 408. The data packet analysis unit 406 may further extract the type of service from the data packets. The data packet analysis unit 406 may also pass additional information to the forwarding decision logic 408, such as virtual LAN information that comes with the packets or is derived based on the type of packets.

The forwarding decision logic 408 is in operative communication with the memory 402 comprising the plurality of rules. The forwarding decision logic 408 examines the source IP address, the destination IP address and the type of service, and applies the plurality of rules to determine whether the data packet(s) should be forwarded and which port or ports it should be forwarded to. The forwarding decision logic 408 may also examine the level of priority of the data packets. In an example, higher priority packets may be forwarded before lower priority frames.

When a data packet does not satisfy the plurality of rules, a decision may be made to not forward the data packet at all to any ports corresponding to the user devices. In such cases, the data packets may be discarded or stored in a quarantine zone 410 within the network device 102. The network device 102 may further include one or more components configured to destroy the data packet not forwarded to the user devices. Further, the network device 102 may implement additional rules to facilitate sending such data packets back to the source. Although the present disclosure does not disclose means of destroying data packets and means for sending data packets back to the source, it may be implemented by a person skilled in the art. Information about the action of restricting the data packet from entering the user device may be sent to the remote server 104.

In some embodiments of the disclosure, the network device 102 may receive an input from the end user's device (e.g. end user's device 106a). The input, as an example, may be a uniform resource locator (URL) associated with a web server responsible for displaying a web page/html page. In another embodiment, the end user's devices 106a, 106b, 106c and 106d may exchange information and files among them. Hence, the one or more of the end user's devices 106a, 106b, 106c and 106d may be the sources of information and one or more of the communication devices 106a, 106b, 106c and 106d may be the destination devices receiving the information. The system 100 may be implemented such that, the network device 102 may constantly monitor traffic or data packets entering the network device 102 before forwarding the data packets to the intended user device (e.g., user device 106a).

The network device 102 receives data packets from a source, wherein the data packets are intended for the end user's device (e.g. end user's device 106a). The data packets received at the network device 102 are stored at the temporary data packet storage 404. The data packet analysis unit 406 may extract the source IP address identifying the source of the data packets. The data packet analysis unit 406 may extract the destination IP address identifying a destination device (e.g. end user's device 106a). Among other information, the data packet analysis unit 406 may also extract the type of service from the data packets. Examples of data packets may include email messages, notifications, http data, ftp data, etc.

The plurality of rules are then applied to the data packets at the forwarding decision logic 408. The forwarding decision logic 408 examines the source IP address, the destination IP address and the type of service, and applies the plurality of rules to determine whether the data packet(s) should be forwarded and which port or ports it should be forwarded to. Based on application of the plurality of rules, the forwarding decision logic 408 forwards the data packets that satisfy the conditions set by the plurality of rules, to the intended end user's device (e.g., end user's device 106a). The forwarding decision logic 408 restricts communication of the data packets that do not satisfy the conditions set by the plurality of rules to the end user's device (e.g., end user's device 106a).

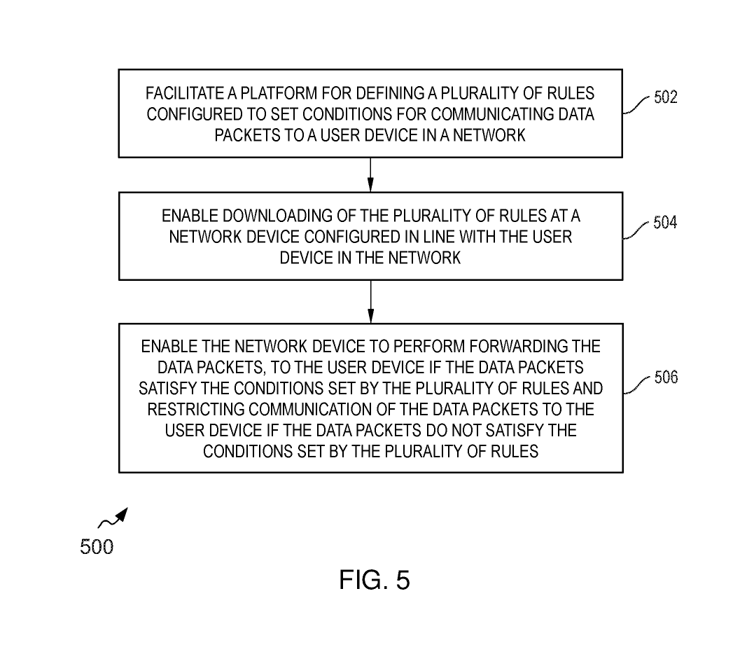

FIG. 5 is a flowchart illustrating an example method 500 for controlling transmission of data packets in a network, in accordance with an example embodiment. The method 500 includes a sequence of operations carried out by the remote server 104 or a remote server with the likes of the remote server 104. The sequence of operations of the method 500 may not be necessarily executed in the same order as they are presented. Further, one or more operations may be grouped together and performed in form of a single step, or one operation may have several sub-steps that may be performed in parallel or in sequential manner.

At operation 502, the remote server 104 facilitates a platform (such as the platform 208) for defining a plurality of rules configured to set conditions for communicating data packets to a user device (e.g. the user device 106a) in a communication network (e.g. the communication network 108). The platform is facilitated by the remote server 104 and can be accessed by an administrator, a network engineer or an end user possessing knowledge to define the plurality of rules.

At operation 504, the remote server 104 enables downloading of the plurality of rules at a network device configured in line with the user device in the communication network (such as communication network 108). The remote server 104 may facilitate the administrator to create identifiers for different network devices available in the communication network. Each network device, such as network device 102 may be referenced using the identifier in the plurality of rules. The remote server 104 allows the network device 102 to download the plurality of rules specific to the network device 102 based on the identifier.

At operation 506, the remote server 104 enables the network device 102 to perform at least forwarding the data packets, to the user device (e.g. user device 106a) if the data packets satisfy the conditions set by the plurality of rules and restricting communication of the data packets to the user device if the data packets do not satisfy the conditions set by the plurality of rules. The network device 102 applies the plurality of rules to the data packet(s) to determine whether the data packet(s) should be forwarded and which port or ports of the user device (e.g. user device 106a) it should be forwarded to.

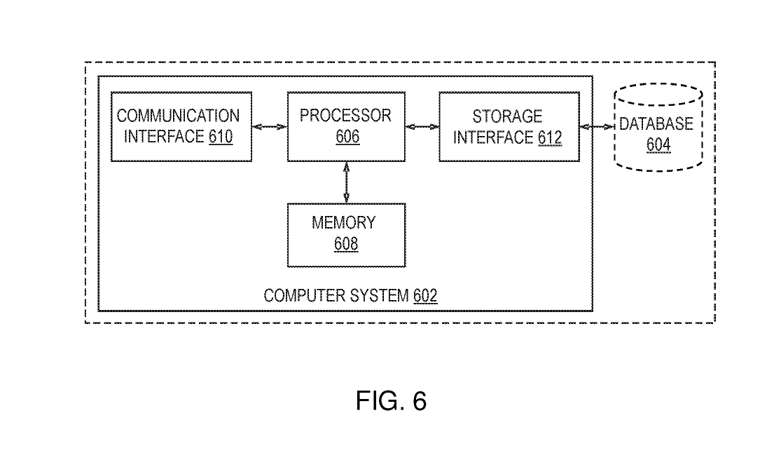

FIG. 6 is a simplified block diagram of a server system 600, in accordance with one embodiment of the present disclosure. The server system 600 is an example of the remote server 104 that is a part of the system 100. The server system 600 includes a computer system 602 and a database 604.

The computer system 602 includes a processor 606 for executing instructions. Instructions may be stored in, for example, but not limited to, a memory 608. The processor 606 may include one or more processing units (e.g., in a multi-core configuration).The processor 606 is operatively coupled to a communication interface 610 such that the computer system 602 is capable of communicating with a remote device such as the network device 102 (shown in FIG. 1)

The processor 606 may also be operatively coupled to the database 604. The database 604 is any computer-operated hardware suitable for storing and/or retrieving data. In a non-limiting example, the database 604 may include multiple storage units such as hard disks and/or solid-state disks in a redundant array of inexpensive disks (RAID) configuration. The database 604 may include a storage area network (SAN) and/or a network attached storage (NAS) system. In some alternate embodiments, the database 604 may also include magnetic storage devices (such as hard disk drives, floppy disks, magnetic tapes, etc.), optical magnetic storage devices (e.g., magneto-optical disks), semiconductor memories (such as mask ROM, PROM (programmable ROM), EPROM (erasable PROM), Phase-change memory, flash ROM, RAM (random access memory)), etc.

In some embodiments, the database 604 is integrated within the computer system 602. For example, the computer system 602 may include one or more hard disk drives as the database 604. In other embodiments, the database 604 is external to computer system 602 and may be accessed by the computer system 602 using a storage interface 612. The storage interface 612 is any component capable of providing the processor 606 with access to the database 604. The storage interface 612 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 606 with access to the database 604.

The memory 608 is a storage device embodied as one or more volatile memory devices, one or more non-volatile memory devices, and/or a combination of one or more volatile memory devices and non-volatile memory devices, for storing micro-contents information and instructions. The memory 608 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry). Particularly, the server system 600 and its various components such as the computer system 602 and the database 604 may be enabled using software and/or using transistors, logic gates, and electrical circuits (for example, integrated circuit circuitry such as ASIC circuitry).

The server 600 as illustrated and hereinafter described is merely illustrative of a system that could benefit from embodiments of the invention and, therefore, should not be taken to limit the scope of the invention. It may be noted that the server 600 may include fewer or more components than those depicted in FIG. 6. As explained above, the server 600 may be included within or embody an electronic device. Moreover, the server 600 may be implemented as a centralized system, or, alternatively, the various components of server 600 may be deployed in a distributed manner while being operatively coupled to each other.

Without in any way limiting the scope, interpretation, or application of the claims appearing below, a technical effect of one or more of the example embodiments disclosed herein is to provide a system for facilitating definition of a plurality of rules in a platform of a remote server. The herein disclosed system provides a remotely programmable solution that is not easily bypassed, requires no networking changes, supports all network devices regardless of their individual manufacturer's support status, and that provides for automatic updating. The platform provides an interface to build auto deployable rules (plurality of rules) for multiple models of network devices for multiple manufacturers.

The disclosed platform facilitates defining identifiers for network devices used for building the plurality of rules. The system facilitates auto deploying of the plurality of rules to network devices to which the plurality of rules are assigned. The system facilitates downloading of the plurality of rules by network devices to which the plurality of rules are assigned. Further, embodiment disclosed herein provides a system for reporting threat information back to the user. The system further incorporates auto updating of the plurality of rules to network devices when an identifier used in the plurality of rules has a change in address or port. The system disclosed herein provides a solution that is economical to produce, easier to manufacture, easier to maintain and more durable.

Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 6. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A computer-implemented method for controlling transmission of data packets in a communication network, the method comprising:
facilitating, by a remote server, a platform for defining a plurality of rules by an administrator of the remote server, the plurality of rules configured to set conditions for communicating data packets to a user device in a communication network;
enabling downloading, by the remote server, the plurality of rules at a network device configured in-line with the user device in the communication network; and
enabling, by the remote server, the network device to perform at least one of:
forwarding data packets to the user device if the data packets satisfy the conditions set by the plurality of rules; and
restricting communication of data packets to the user device if the data packets do not satisfy the conditions set by the plurality of rules.

2. The method as claimed in claim 1, wherein facilitating the platform further comprises:
facilitating defining a network address corresponding to the network device;
facilitating defining one or more ports of the network device for:
receiving data packets from one or more sources and for forwarding to the user device, and
receiving data packets from the user device for forwarding to the one or more sources; and
facilitating defining at least one port associated with the user device in the network for exchanging data packets with the network device.

3. The method as claimed in claim 2, wherein defining the plurality of rules further comprises defining rules for allowing communication of data packets at the network addresses and on the one or more ports.

4. The method as claimed in claim 1, further comprising deploying at the network device the plurality of rules assigned to the network device.

5. The method as claimed in claim 1, further comprising enabling the administrator to create an identifier corresponding to the network device, wherein the identifier is used while defining the plurality of rules.

6. The method as claimed in claim 1, wherein the plurality of rules comprises data packet filtering rules.

7. The method as claimed in claim 6, wherein the data packet filtering rules further comprise one or more conditions for exchanging data packets between the network device and the user device.

8. The method as claimed in claim 1, further comprising:
receiving an input from the user device, the input querying about a web page associated with a source of the web page;
downloading the plurality of rules from the remote server;
receiving data packets from the source, wherein data packets are intended for the user device; and
applying the plurality of rules to perform at least one of:
forwarding data packets that satisfy the conditions set by the plurality of rules to the user device; and
restricting communication of data packets that do not satisfy the conditions set by the plurality of rules to the user device.

9. A system for controlling transmission of data packets in a communication network, the system comprising:
a remote server comprising a plurality of rules configured to set conditions to communicate data packets to a user device in the network; and
a network device in-line with the user device in the network, the network device configured to:
download the plurality of rules from the remote server; and
perform at least one of:
forwarding the data packets to the user device if the data packets satisfy the conditions set by the plurality of rules; and
restricting communication of the data packets to the user device if the data packets do not satisfy the conditions set by the plurality of rules.

10. The system as claimed in claim 9, wherein the remote server facilitates a platform for defining the plurality of rules.

11. The system as claimed in claim 10, wherein the platform is configured to:
facilitate defining a network address corresponding to the network device;
facilitate defining one or more ports of the network device for:
receiving data packets from one or more sources and for forwarding to the user device; and
receiving data packets from the user device and for forwarding to the one or more sources; and facilitate defining at least one port associated with the user device in the network for exchanging data packets with the network device.

12. The system as claimed in claim 11, wherein the plurality of rules further comprises rules for allowing communication of the data packets at the network address and on the one or more ports.

13. The system as claimed in claim 9, wherein the plurality of rules are specific to the network device.

14. The system as claimed in claim 10, wherein the platform enables an administrator to create an identifier corresponding to the network device, wherein the identifier is used while defining the plurality of rules.

15. The system as claimed in claim 14, wherein the network device is configured to update the plurality of rules when the identifier corresponding to the network device is updated.

16. The system as claimed in claim 10, wherein the plurality of rules comprises data packet filtering rules.

17. The system as claimed in claim 16, wherein the data packet filtering rules further comprise one or more conditions for exchanging data packets between the network device and the user device.

18. A remote server comprising:
a memory configured to store a plurality of rules configured to set conditions for exchanging data packets with one or more communication devices in a communication network; and
at least one processor in operative communication with the memory, the at least one processor configured to:
enable a network device to download the plurality of rules, wherein the network device is configured in-line with the one or more communication devices in the communication network; and
enable the network device to perform at least one of:
allow communication of the data packets to the one or more communication devices if the data packets satisfy the conditions set by the plurality of rules; and
restrict communication of the data packets to the one or more communication devices if the data packets do not satisfy the conditions set by the plurality of rules.

19. The remote server as claimed in claim 18,further configured to facilitate a platform for defining a plurality of rules.

20. The remote server as claimed in claim 18, wherein the platform is configured to:
facilitate defining a network address corresponding to the network device;
facilitate defining one or more ports of the network device for:
receiving data packets from one or more sources and for forwarding to the user device; and
receiving data packets from the user device and for forwarding to the one or more sources; and
facilitate defining at least one port associated with the user device in the network for exchanging data packets with the network device.
